(19) United States
(12) Patent Application Publication
(10) Pub. No.: US 2001/0029691 A1
(43) Pub. Date: Oct. 18, 2001

(54) One piece duck decoy

(76) Inventor: Vito A. Angelone, Cross Junction, VA (US)

Correspondence Address: WEINGARTEN, SCHURGIN, GAGNEBIN, & HAYES, LLP, TEN POST OFFICE SQUARE, BOSTON, MA, 02109, US

(21) Appl. No.: 09/845,806

(22) Filed: Apr. 30, 2001

Related U.S. Application Data
(60) Provisional application No. 60/200,857, filed on May 1, 2000.

(51) Int. Cl. A01M 31/06

(52) U.S. Cl. 43/3

(57) ABSTRACT

A duck decoy is provided which is molded or otherwise formed in a unitary manner from high density material such as polyurethane. The decoy floats and has a low profile and lifelike appearance and can be made to simulate the appearance of many duck species. The decoy is fabricated in single unitary piece including the head and body portions. The high density material has a high impact resistance of about 900 pounds per square inch and is extremely rugged. The decoy can withstand a shotgun blast without losing its appearance and without losing its structural integrity. The decoy is extremely light and typically weights about 6-8 ounces. The decoy can be hand painted and have realistic taxidermy glass eyes. The decoys are one of the lightest decoys commercially available without losing their durable rugged quality. The decoy has a low profile and a resting position of the head. The low profile and low weight of the decoy allows a hunter to carry several dozen decoys in a bag without assistance. The bottom is flat and can include a keel for floating stability. Because of its broad profile, it is particularly stable in rough waters. The decoys are unsinkable.

### CROSS REFERENCE TO RELATED APPLICATIONS

Priority is claimed under 35 U.S.C. 119(e) of U.S. Provisional Application No. 60/200,857 filed on May 1, 2000, entitled: ONE PIECE DUCK DECOY, the disclosure of which is incorporated by reference herein.

### BACKGROUND OF THE INVENTION

Duck decoys are often hand carved out of wood and are hand painted to provide a lifelike appearance. Decoys are also known which are made of other buoyant materials. A fin or keel may extend from the bottom of the decoy body. Often the decoy has a rigid plastic outer shell filled with a buoyant foam plastic material and a weighted keel to maintain an intended floatation level when the decoy is placed in the water. The head is often fabricated separately from the body and attached thereto. These existing decoys have not been fully satisfactory in several respects. The decoys do not rest in the water in a lifelike manner and therefore do not serve the intended purpose of attracting actual water fowl. In rough waters, the decoys wobble and can flip over. In addition existing decoys are not sufficiently durable to withstand a shotgun blast without losing their appearance and structural integrity.

### BRIEF SUMMARY OF THE INVENTION

In accordance with the present invention, a duck decoy is provided which is molded or otherwise formed in a unitary manner from high density buoyant material such as polyurethane. The decoy is unsinkable and has a low profile and lifelike appearance and can be made to simulate the appearance of many duck species. The decoy is fabricated in single unitary piece including the head and body portions. The high density material has a high impact resistance of about 900 pounds per square inch and is extremely rugged. The decoy can withstand a shotgun blast without losing its appearance and without losing its structural integrity. The decoy is extremely light and typically weights about 6-8 ounces. The decoy can be hand painted and have realistic taxidermy glass eyes. The decoys are one of the lightest decoys commercially available without losing their durable rugged quality. The decoy has a low profile and a resting position of the head. The low profile and low weight of the decoy allows a hunter to carry several dozen decoys in a bag without assistance.

The bottom is flat and can include a center keel for floating stability. Because of its broad profile, it is particularly stable in rough waters and does not rock or flip over, as can conventional decoys.

### BRIEF DESCRIPTION OF THE SEVERAL VIEWS OF THE DRAWING

FIG. 1 shows a profile view of the decoy.

FIG. 2 shows a front view of the decoy.

FIG. 3 shows a top view of the decoy.

FIG. 4 shows a side view of the decoy.

FIG. 5 shows the bottom view of the decoy.

FIG. 6 shows the position of the decoy when floating in water.

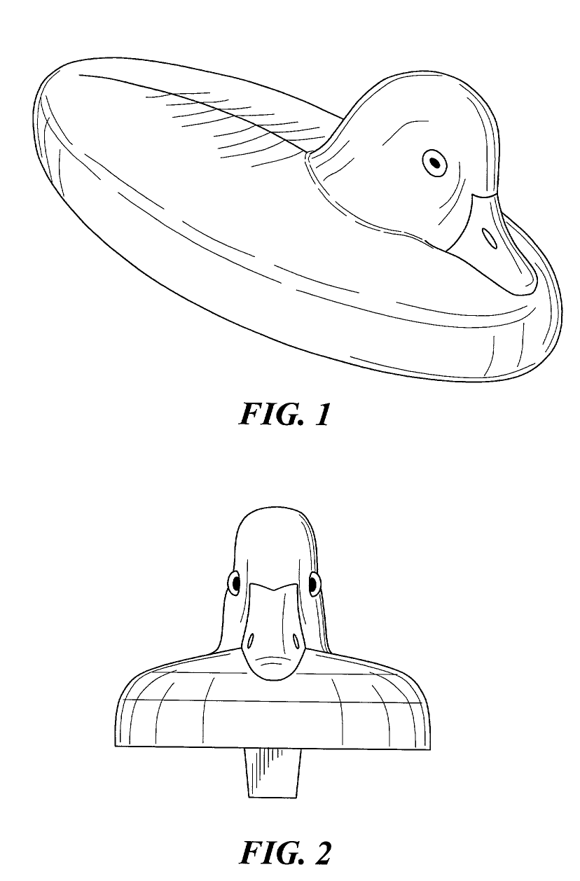

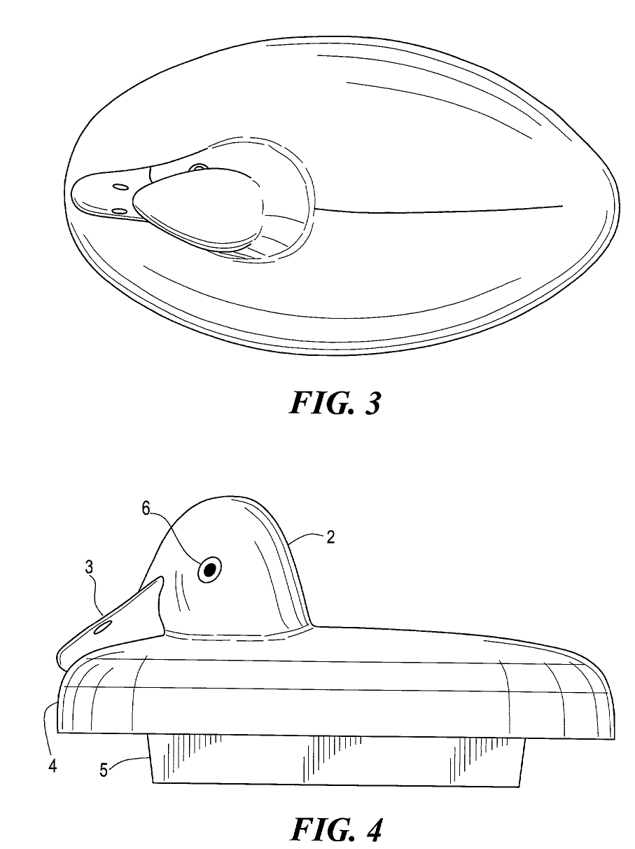

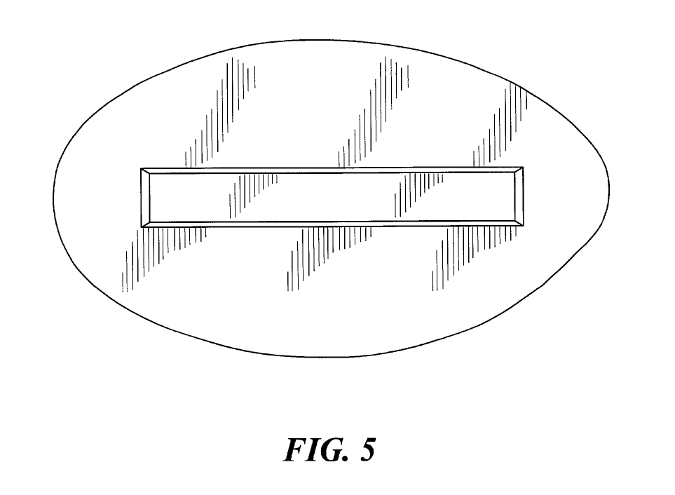

### DETAILED DESCRIPTION OF THE INVENTION

The instant invention relates to a duck decoy that is extremely realistic, when compared to the behavior and appearance of many duck species, is easy to make, is lightweight, and is extremely durable.

Although the description herein relates to a duck decoy, what is stated is equally applicable to decoys simulating other waterfowl and water birds. Examples of other waterfowl and birds which can be made from the same mold as that used for the duck include Golden eye, Buffle head, Canvas back, Broad bill, Red head, and Ring neck. Since these animals differ primarily in feather color, these decoys can be made simply by using different color paint. Examples of other animals which require different molds are Goose, Mallard, Teal, and Brant.

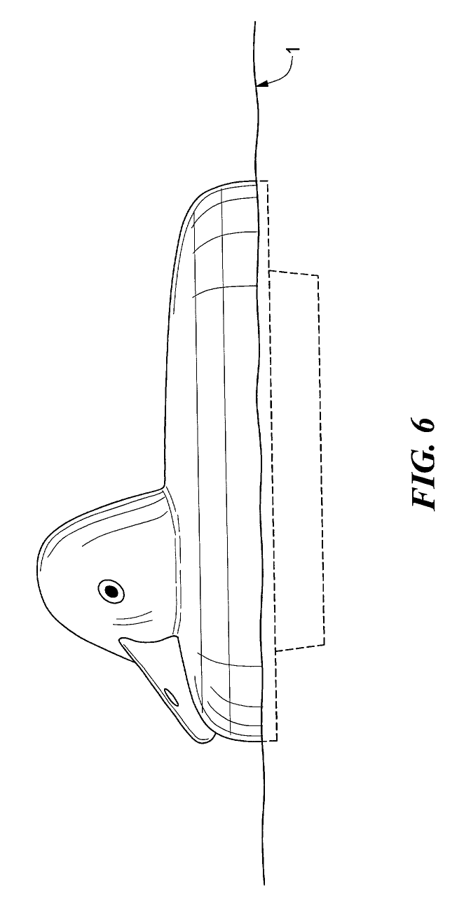

In terms of appearance, the decoy is similar to a live duck in terms of amount of body that is exposed above the water line. (See FIG. 6, where the water line is 1.) The novel decoy floats much lower in the water than conventional decoys. The position of the head (2 in FIG. 4) is such that the beak 3 is resting on the body 4, like that of a duck at rest. The decoy also has comparatively little wobble in rough water, due to the wide base and the low profile of the head and body. Preferably the base (excluding the head portion) has a width to body height ratio in the range of 4:1 to 3:1. The decoy has a flat bottom and can have one or more keels, preferably one center keel 5, for added floating stability. Alternatively, the bottom can be concave.

One preferred method of manufacture of the decoy is begun by the design of a mold for the decoy of an intended species. The mold can be prepared in any acceptable manner (e.g., by hand or by machine crafting). Once the mold is made, an appropriate amount of paint primer can optionally be sprayed or otherwise applied to the mold surfaces. The foam material is then injected into the mold. This foam material can be any buoyant material, preferably high density polyurethane, and more preferably 900 lb. high density polyurethane. The foam material absorbs the paint primer, if any, previously sprayed into the mold. The formed duck is removed from the mold and further decorated to simulate the appearance of a particular species of duck. This decoration can include applying a finish paint coat, preferably with acrylic paint, either by hand or machine, to simulate the coloration of a particular species, the insertion of artificial eyes 6, which preferably are realistic taxidermy glass eyes.

The decoy according to the invention has numerous advantages over other decoys of conventional design. First, it is lightweight, typically about 6-8 ounces, which means that a person can easily carry a large number of these decoys. Second, the shape of the decoy, due to the position of the head being tucked into the body, allows a relatively large number of decoys to be carried in a given sized container. Third, because of the possible use of the primer coat of paint, the final decorating paint coat is quite durably adherent to the body. The high density polyurethane is resistant to damage from shot, thus ensuring that the decoy is relatively durable and long-lasting. In addition, the buoyant foam material is quite resistant to gasoline and other solvents that may be utilized in a boat, further improving its durability. As indicated previously, the decoy is quite realistic when in the water, from the standpoint of the amount of duck exposed when floating, the position of the head, and stability in rough water.

It will be apparent to those skilled in the art that other modifications to and variations of the above-described techniques are possible without departing from the inventive concepts disclosed herein. Accordingly, the invention should be viewed as limited solely by the scope and spirit of the appended claims.

What is claimed is:

1. A one-piece bird decoy comprising:
a unitary body of high density, high impact resistant buoyant material in the shape of a duck;
a head integral with the body and disposed in a resting position on the body; and
the body having a large width to body height ratio and capable of floating low in the water.

2. The decoy of claim 1 wherein said bird is a duck.

3. The decoy of claim 1 wherein said buoyant material is high density polyurethane.

4. The decoy of claim 3 wherein the high density polyurethane has an impact resistance of about 900 pounds per square inch.

5. The decoy of claim 3 further comprising a keel extending from the bottom of the body and along the length of the body.

6. The decoy of claim 5 wherein the bottom of said decoy is flat.

7. The decoy of claim 5 which further comprises a primer coat of paint adherent to the surface of the body and integral head.

8. The decoy of claim 5 which further comprises a decorative coat of paint representing duck plumage.

9. The decoy of claim 8 which further comprises artificial eyes.

10. A process for making a one piece, buoyant bird decoy comprising the steps of:
a. preparing a mold,
b. injecting into said mold a buoyant material, and
c. decorating said decoy to resemble a resting duck.

11. The process of claim 10 wherein said buoyant material is high density polyurethane.

12. The process of claim 10 which also comprises the injection of paint primer into said mold prior to the injection of said buoyant material.
